(19) United States
(12) Patent Application Publication
(10) Pub. No.: US 2014/0121316 A1
(43) Pub. Date: May 1, 2014

(54) SILANE FUNCTIONALIZED OLIGOMER AND RUBBER COMPOUND COMPRISING THE SAME

(71) Applicant: CRAY VALLEY USA, LLC, Exton, PA (US)

(72) Inventors: Jean-Marc Monsallier, Saint Martin Longueau (FR); Steven K. Henning, Downingtown, PA (US)

(73) Assignee: Cray Valley USA, LLC, Exton, PA (US)

(21) Appl. No.: 13/796,177

(22) Filed: Mar. 12, 2013

Related U.S. Application Data
(60) Provisional application No. 61/721,201, filed on Nov. 1, 2012.

(51) Int. Cl. C08L 47/00

(52) U.S. Cl. CPC C08L 47/00
USPC 524/526

(57) ABSTRACT

A rubber composition includes high molecular weight diene elastomer, 5 to 120 phr of silica, 0 to 100 phr of a carbon black, and a silane modified oligomer including diene monomers and optionally vinyl aromatic monomers in polymerized form, wherein the silane modified oligomer has a molecular weight of 1000 to 5000 g/mol. A method of making the rubber composition includes compound mixing the components of the rubber composition in situ.

### CROSS-REFERENCE TO RELATED APPLICATIONS

This application claims priority of U.S. Provisional Patent Application No. 61/721,201, filed Nov. 1, 2012, the disclosure of which is incorporated herein by reference in its entirety for all purposes.

### FIELD OF THE INVENTION

This invention relates generally to dispersing and coupling agents, particularly silane functionalized oligomers of diene and vinyl aromatic monomers, and rubber compositions incorporating the same. The rubber compositions are used in applications such as tires.

### BACKGROUND OF THE INVENTION

When producing rubber compositions, it is common to utilize fillers for the purpose of reducing costs by replacing higher priced constituents of the rubber composition while at the same time imparting some additional functionality or improved properties to the final rubber product. However, in order to achieve these advantages, the use of additives in combination with the fillers may be necessary. For example, German patent DE 3010113 granted to Chemische Werke Huels A.-G discloses the use of a polybutadiene having a grafted silyl group used as couplers for mineral fillers in polymers. Another German patent, DE 3129082, granted to the same company discloses a silane grafted polybutadiene, which is used as couplers for inorganic fillers. An issued Japanese patent, JP 62265301, to Nippon Soda Co. describes the preparation of a silane-grafted polybutadiene used as a surface treating agent for mineral fillers.

Fillers, which may not by themselves be able to improve the mechanical properties of the rubber composition, are often combined with dispersing and coupling agents. The dispersing and coupling agents physically or chemically interact with the polymer matrix and the filler at the boundary between the two phases and have the potential to impart improved physical properties in the rubber composition.

A possible application for the use of dispersing and coupling agents is in rubber compositions. For example, U.S. Pat. Nos. 4,381,377 and 4,396,751 disclose a silane-grafted polybutadiene used in sulfur-cured EPDM to form a crosslinked product having an improved modulus and curing rate. By manipulating rubber compositions, specific advantageous physical properties for tires made from such compositions is of particular interest for tire manufacturers. Reducing fuel consumption may be obtained by developing tires having a very low rolling resistance combined with excellent grip properties and handling behavior. This can produce significant cost and environmental benefits because improved physical properties of the tires can reduce fuel consumption. Therefore, some research has been concentrated on the potential use of such dispersing and coupling agents. European Patent 1013710 to Nippon Mitsubishi Oil Corporation describes the use of silane-grafted polybutadiene in tires for improving mechanical strength, fuel consumption properties, and traction. In U.S. Pat. No. 4,397,994 granted to JSR, a high vinyl polybutadiene or styrene-butadiene copolymer capped or linked with silicon, germanium, tin or lead is disclosed that upon vulcanization provides a rubber tire having low rolling resistance, high wet skid resistance, and highly improved fracture property. Similar results are disclosed in JP 2009-084413 assigned to Nippon Zeon Co. Ltd. in which the use of silicone modified polybutadiene rubber in a tire formulation containing silica and natural rubber has good wear resistance and low heat build-up, and in two applications to Yokohama Rubber Co., Ltd., JP 2005-350603 and JP 2006-063209, a rubber composition is provided having improved unvulcanized physical properties and includes a hydrocarbon polymer having at least two terminal organosilicon functional groups bonded through urethane bonds.

There is therefore a need for additional dispersing and coupling agents that will reduce manufacturing costs and produce rubber compositions having improved physical properties.

### SUMMARY OF THE INVENTION

According to one embodiment of the invention, a rubber composition is disclosed comprising high molecular weight diene-based elastomer, 5 to 120 phr of silica, 0 to 100 phr of a carbon black, and a silane modified oligomer comprising diene monomers and optionally vinyl aromatic monomers in polymerized form, wherein the silane modified oligomer has a molecular weight of 1000 to 5000 g/mol.

“Low molecular weight” as used herein means a molecular weight of about 1000 to about 5000.

“Oligomer” as used herein means a compound which is the product of the polymerization of monomers having a degree of polymerization of about 10 to 100 and a molecular weight of about 500 to 10,000.

According to another embodiment of the invention, a method of making a rubber composition is disclosed comprising compound mixing in situ high molecular weight diene elastomer, 5 to 120 phr of silica, 0 to 100 phr of a carbon black, and a silane modified oligomer comprising diene monomers and optionally vinyl aromatic monomers in polymerized form, wherein the silane modified oligomer has a molecular weight of 1000 to 5000 g/mol.

### BRIEF DESCRIPTION OF THE DRAWING

In order that the invention may be more fully understood, the following figure is provided by way of illustration, in which:

FIG. 1 is a comparison of the Payne Effect of the three rubber compound samples of Example 1.

### DETAILED DESCRIPTION OF THE INVENTION

Applicants have discovered that improved silica dispersion may be achieved by the addition of a terminal-silane functional low molecular weight compound, such as polybutadiene, in a rubber compound containing silica and silane coupling agents as fillers. The improvement in silica dispersion through the use of the low molecular weight silane functional compound results in improved viscoelastic properties which can be correlated to increased fuel economy, higher wet traction, and improved winter performance in tire tread compounds.

According to one embodiment, the invention is a sulfur-vulcanizable silica containing rubber compound with improved processability and dynamic properties which contains at least a silane modified low molecular weight oligomer comprising diene monomers, and optionally vinyl aromatic monomers, in polymerized form. The rubber composition further comprises 5 to 120 parts of a silica, 0 to 100 parts of a carbon black, and 100 phr of high molecular weight diene-based elastomers, such as styrene butadiene, butadiene, polyisoprene, or natural rubber, or blends of these rubber elastomers.

The silane modified low molecular weight oligomer is preferably a silane modified low molecular weight polybutadiene, more preferably having a molecular weight of 2000 to 4000, and most preferably having molecular weight 2500 to 3500.

Non-functionalized liquid polybutadiene has been used in tire compounding. Due to their wide range of glass transition temperatures (Tg), low molecular weight diene elastomers are used as plasticizers to increase the grip properties and the handling behavior of tires. However, these low-molecular weight non-functionalized polymers can have the disadvantage of producing tires with poor rolling resistance performance.

Applicants have discovered that by replacing the non-functionalized polymers with the low-molecular weight silane functionalized oligomers of the present invention in a silica containing rubber compound, improved silica dispersion, processing, rolling resistance, winter properties, wet grip and handling behavior is realized. The silane-functional low molecular weight oligomer may be added to the silica in situ during compound mixing, rather than pre-blending or pre-reacting the adhesion promoter with the silica filler, which provides additional advantages by reducing the number of steps involved in the compounding process.

The oligomer used in the present invention can be made in several ways; for example, by the homopolymerization of a conjugated diolefin monomer, by the random copolymerization of a conjugated diolefin monomer with a vinyl aromatic monomer, or by polymerizing a mixture of conjugated diolefin monomers with one or more ethylenically unsaturated monomers, such as vinyl aromatic monomers. The conjugated diolefin monomers generally contain from 4 to 12 carbon atoms, preferably from 4 to 8 carbon atoms, such as 1,3-butadiene and isoprene. Additional conjugated diolefin monomers include 2,3-dimethyl-1,3-butadiene, piperylene, 3-butyl-1,3-octadiene, and 2-phenyl-1,3-butadiene either alone or in admixture. Vinyl aromatic monomers include those which are copolymerizable with the selected conjugated diolefin monomers. The vinyl aromatic monomers preferably contain from 8 to 20 carbon atoms, more preferably from 8 to 14 carbon atoms, such as styrene. Additional vinyl aromatic monomers include α-methylstyrene, bromostyrene, chlorostyrene, and fluorostyrene either alone or in admixture.

Various methods may be employed to produce the silane modified low molecular weight oligomer of the present invention. A first process includes producing a silane grafted polybutadiene by grafting mercaptosilane on polybutadiene having 20% vinyl content and a molecular weight of 5000 in the presence of azobisisobutylnitrile (AIBN) radical initiator. A second process includes producing a silane-terminated polybutadiene by anionic polymerization and capping the living end of the polybutadiene with tetraethoxysilane instead of protons.

The high molecular weight diene-based elastomers may be selected from the group consisting of polybutadiene, polyisoprene, copolymers of butadiene and vinyl aromatic monomers or isoprene and vinyl aromatic monomers, and mixtures of two or more thereof. For example, elastomers that may be used in the present invention include styrene-isoprene-butadiene rubber (SIBR), styrene-isoprene rubber (SIR), isoprene-butadiene rubber (IBR). Natural rubber can also be used in addition to synthetic rubbers which may include neoprene (polychloroprene), polybutadiene (including cis 1,4-polybutadiene), polyisoprene (including cis-1,4-polyisoprene), butyl rubber, halobutyl rubber such as chlorobutyl rubber or bromobutyl rubber, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include a carboxylated rubber, silicon-coupled and tin-coupled star-branched polymers.

The silica and carbon black used in the present invention may include various commercially available products known in the art. For example, silicas commercially available from PPG Industries under the Hi-Sil trademark with designations 210, 243, etc; silicas available from Rhodia, with, for example, designations of Z1165MP and Z165GR and silicas available from Degussa AG with, for example, designations VN2 and VN3, etc. Representative examples of carbon blacks include N110, N121, N220, N231, N234, N242, N293, N299, S315, N326, N330, N332, N339, N343, N347, N351, N358, N375, N539, N550, N582, N630, N642, N650, N683, N754, N762, N765, N774, N787, N907, N908, N990 and N991.

It is readily understood by those having skill in the art that the compositions of the present invention may be compounded by methods generally known in the rubber compounding art, such as mixing various sulfur-vulcanizable constituent rubbers with various commonly used sulfur-based vulcanizing agents such as, for example, sulfur donors. Examples of sulfur donors include elemental sulfur (free sulfur), an amine disulfide, polymeric polysulfide, and sulfur olefin adducts. It is also readily understood by those having skill in the art that the composition of the present invention may include other additives, such as curing aids, resins including tackifying resins and plasticizers, process oils, fillers, pigments, fatty acid, zinc oxide, waxes, antioxidants and antiozonants and peptizing agents. Typical process oils include aromatic, paraffinic, napthenic, and low PCA oils such as MEW, TDAE, and heavy napthenic. Typical antioxidants include diphenyl-p-phenylenediamine. Typical peptizers include pentachlorothiophenol and dibenzamidodiphenyl disulfide. Any of the usual vulcanization processes may be used such as heating with superheated steam or hot air in a press or mold.

### COMPARATIVE EXAMPLES

In order that the invention may be more fully understood the following Examples are provided by way of illustration only.

The following properties were examined to determine the effect on the thermodynamic properties of the final rubber compound that includes a silane functionalized oligomer:

The effect of mono-functionalization on high Tg and low Tg oligomer;

The effect of high functionalization on high Tg and low Tg oligomers;

Influence of molecular weight; and

Influence of position of the silane on the polymer chain (terminal vs. grafted in chain).

For tire applications:

tan δ at 0° C. (or rebound at 23° C.) is used as a lab indicator for wet traction properties. A higher tan δ at 0° C. (or lower rebound at 23° C.) means improved wet traction properties.

tan δ at 60° C. (or rebound at 70° C.) is used as a lab indicator for rolling resistance (also called fuel consumption). A lower tan δ at 60° C. (or higher rebound at 70° C.) means improved rolling resistance properties.

J′ at −20° C. is used as a lab indicator for winter properties. A higher J′ at −20° C. means improved winter properties.

### Compounding Procedure

Various rubber compositions were prepared containing the constituents in the proportions provided by Table 1.

TABLE 1

| Ingredients | Phr |
|---|---|
| High Cis Butadiene Rubber | 25 |
| Solution Styrene Butadiene Rubber | 75 |
| Silica | 85 |
| Silane | 6.8 |
| N-(1,3-Dimethylbutyl)-N′-phenyl-pphenylenediamine | 2 |
| 2,2,4-trimethyl-1,2-dihydroquinoline | 2 |
| Ozone Wax | 2 |
| Low molecular weight oligomer | 25 |

The rubber compound compositions were prepared by first mixing the materials listed in Table 1 through an internal mixer (two passes, speed 50 rpm, start temperature 120° C., and a maximum temperature of 145-150° C.). The materials were then transferred to an open mixer to which vulcanizing agents were added, 2.8 phr each of sulfur, TBBS, stearic acid, and zinc oxide. Finally, the rubber compound samples were vulcanized at 200 bar at 160° C. for twenty-five minutes.

In each of the following examples, the properties of the low-molecular weight oligomer were determined as follows:

Viscosity—A brookfield viscometer was used to determine the apparent viscosity of the samples at 25° C. The samples were placed below the viscometer and the spindle, (SC4-27), was introduced into the liquid at an angle to avoid interference with potential air bubbles. The frequency of rotation was adapted to reach between 45 and 95% of deformation given by the apparatus and the reading was taken after 15 minutes;

Glass Transition Temperature—The glass transition temperature was measured by differential scanning calorimetry using a DMA Q800 manufactured by TA Instruments. Six milligram samples were placed in the analysis chamber. Nitrogen flow was used in the analysis chamber to provide inert conditions. A heating rate of 10° C./min was used and two scans were run from −100° C. to 120° C.; and

Molecular Weight—Molecular weights were determined by Gel Permeation Chromatography using the following:

chromatograph with R1 detector manufactured by Hewlett Packard;

stainless steel column, 250 mm length, 4.6 mm internal diameter;

packing: LiChrospher® S±100 manufactured by EMD Millipore of Billerica, Mass.;

mobile phase: THF;

flow rate: 1.0 ml/min;

toluene as an internal standard; and

a universal calibration method (Polystyrene as standards, calculated for polybutadiene using Mark-Houwink parameters).

### Example 1

Three rubber compound samples were made according to the Compounding Procedure. The first sample contained Sundex 790, a high aromatic processing oil manufactured by Petronas Lubricants Belgium Nev., instead of a low molecular weight oligomer. The second sample contained Ricon® 130, a low molecular weight polybutadiene manufactured by Cray Valley of Exton, Pa. The third sample (Sample A) contained a siloxane modified polybutadiene. The siloxane modified polybutadiene had the following properties: Mn=2667 g/mol, 17% vinyl, Tg=−90° C., Viscosity @25° C.=860 mPa·s, 1 terminal functional group.

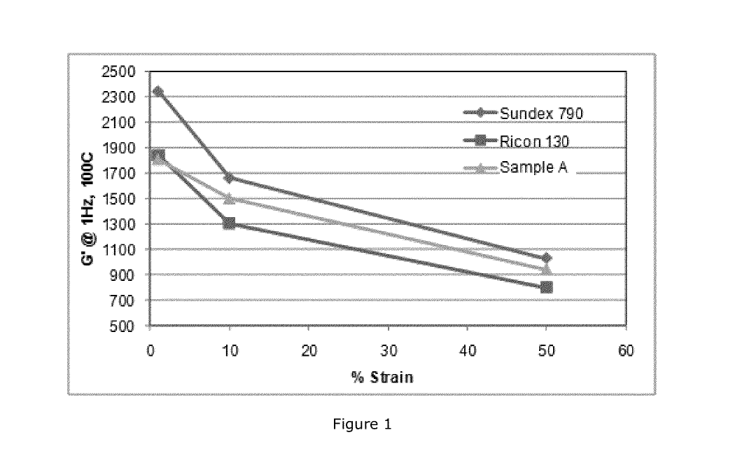

Referring to Table 2 and FIG. 1, the rubber sample containing Ricon® 130 exhibited values suggesting inferior tensile properties than the sample containing Sundex 790; however, the use of the low molecular weight siloxane modified oligomer mitigated that effect. For certain measurements, such as those used to determine hysteresis and traction properties of the rubber compound, the results suggest that Sample A is an improved product.

TABLE 2

| | Sundex 790 | Ricon 130 | Sample A |
|---|---|---|---|
| MH-ML | 30.7 | 23.8 | 29.8 |
| 100% modulus | 2.7 | 2.1 | 2.7 |
| Rebound (23° C.) | 37 | 41 | 42 |
| Rebound (70° C.) | 68 | 63 | 66 |
| Tan δ (0° C.) | 0.51 | 0.46 | 0.58 |
| Tan δ (60° C.) | 0.105 | 0.116 | 0.077 |
| J′ −20° C. | 0.00126 | 0.00221 | 0.00282 |

### Example 2

Two rubber compound samples were made according to the Compounding Procedure. Sample 1 contained a non-functionalized equivalent to the low molecular weight oligomer used in the second sample. The second sample utilized a siloxane modified polybutadiene (Sample B) having the following properties: Mn=3000 g/mol, 60% vinyl, Tg=−40° C., Viscosity @25° C.=9199 mPa·s, 1 terminal functional group.

The physical properties of the Sample 1 and Sample B were determined and are provided in Table 3.

TABLE 3

| Physical Property | Sample 1 | Sample B |
|---|---|---|
| ML (1 + 4) | 67 | 41 |
| Shore A | 57 | 53 |
| MH-ML | 17.2 | 14.1 |
| M100% | 2.7 | 2 |
| M300% | 11 | 8.4 |
| Elongation % | 417 | 474 |
| Tensile Strength (mPa) | 17 | 15.5 |
| Rebound (23° C.) | 36 | 33 |
| Rebound (70° C.) | 50 | 53 |

Comparison of the physical properties of the two samples indicates that the rubber compound containing the siloxane modified polybutadiene has improved silica dispersion, better wet traction, and rolling resistance.

### Example 3

Three rubber compound samples were made according to the Compounding Procedure. The first sample contained Vivatec 500, an aromatic oil manufactured by Tudapetrol KG, instead of a low molecular weight oligomer. Sample 2 contained a non-functionalized equivalent to the low molecular weight oligomer used in the third sample. The third sample (Sample C) contained a siloxane modified polybutadiene. The siloxane modified polybutadiene had the following properties: Mn=3200 g/mol, 57% vinyl, Tg=−40° C., Viscosity @25° C.=10650 mPa·s, 2 terminal functional groups.

Referring to Table 4 and FIG. 2, Sample 2 in some respects exhibited values suggesting inferior tensile properties than the sample containing Vivatec 500; however, the use of the low molecular weight siloxane modified polybutadiene provided both higher wet traction and lower rolling resistance indicators, suggesting that Sample C is an improved product.

TABLE 4

| | Vivatec 500 | Sample 2 | Sample C |
|---|---|---|---|
| MH-ML | 21.9 | 17.2 | 22.3 |
| 100% modulus | 3.4 | 2.7 | 4.1 |
| Rebound (23° C.) | 38.7 | 36.2 | 42.2 |
| Rebound (70° C.) | 56.2 | 50.9 | 62.0 |
| Tan δ (0° C.) | 0.25 | 0.22 | 0.39 |
| Tan δ (60° C.) | 0.07 | 0.11 | 0.07 |

### Example 4

Two rubber compound samples were made according to the Compounding Procedure. The first sample contained a low molecular weight polybutadiene as the low molecular weight oligomer (Sample 3), while the second sample utilized a siloxane modified polybutadiene (Sample D) having the following properties: Mn=3000 g/mol, 20% vinyl, Tg=−65° C., Viscosity @25° C. 9475 mPa·s, average of 2.3 terminal functional groups.

The physical properties of the Sample 3 and Sample D, although not conclusive, did suggest a significant improvement in hysteresis. The properties of Sample 3 and Sample D are provided in Table 5.

TABLE 5

| Physical Property | Sample 3 | Sample D |
|---|---|---|
| ML (1 + 4) | 75.5 | 61 |
| MH-ML | 19.5 | 22.6 |
| Shore A | 68 | 74.5 |
| M100% | 2.2 | 4.9 |
| M300% | 5.2 | — |
| M300/M100 | 2.4 | — |
| Elongation % | 655 | 240 |
| Tensile Strength | 13.3 | 10.4 |
| Rebound RT | 41.5 | 47.7 |
| Rebound (70° C.) | 47.4 | 61.8 |
| Tan δ (0° C.) | 0.23 | 0.25 |
| Tan δ (60° C.) | 0.14 | 0.10 |
| J′ (0° C.)-μm²/N | 58600 | 54100 |

### Example 5

Six samples (Samples 4-9) were prepared using the Compounding Procedure in which low molecular weight polybutadiene homopolymers of various weight and Tg were added as the low molecular weight oligomer. The results are provided in Table 6 and generally demonstrate improved physical properties for the samples containing homopolymers of lower molecular weights.

TABLE 6

| | Sample | | | | | |
|---|---|---|---|---|---|---|
| | 4 | 5 | 6 | 7 | 8 | 9 |
| Vinyl % | 28 | 28 | 28 | 65 | 65 | 65 |
| Tg (° C.) | −90 | −90 | −90 | −35 | −35 | −35 |
| Mn (g/mol) | 2000 | 3000 | 5000 | 2000 | 3000 | 5000 |
| Visc. ML | 52 | 53 | 73 | 55 | 54 | 74 |
| (1 + 4) | | | | | | |
| MH-ML | 10.8 | 11.2 | 14 | 26.6 | 21.2 | 16.8 |
| Shore A | 52 | 52 | 55 | 73 | 68 | 65 |
| M100% | 1.7 | 2.1 | 2.2 | 5.4 | 3.8 | 3.7 |
| M300% | 5.6 | 7.9 | 6.9 | — | — | 7.3 |
| Tensile | 15.4 | 15.6 | 15.7 | 11.4 | 12.7 | 10.1 |
| Strength | | | | | | |
| Elongation | 624 | 490 | 529 | 169 | 281 | 311 |
| Abrasion | 153 | 114 | 101 | 121 | 119 | 108 |
| Rebound (RT) | 41 | 40 | 11 | 41 | 43 | 44 |
| Rebound | 54 | 50 | 50.4 | 63 | 60 | 57 |
| (70° C.) | | | | | | |
| Tan δ (0° C.) | 0.15 | 0.15 | 0.17 | 0.39 | 0.35 | 0.32 |
| Tan δ (60° C.) | 0.10 | 0.12 | 0.13 | 0.08 | 0.09 | 0.11 |
| J′ (0° C.) × | 3.4 | 3 | 2.2 | — | — | — |
| 10(7) | | | | | | |

### Example 6

To determine the effect on the physical properties of a rubber compound by adding a siloxane grafted low molecular weight oligomer, two samples were prepared according to the Compounding Procedure, one using a non-functionalized low molecular weight polybutadiene (Sample 10) and one using a low molecular weight siloxane grafted polybutadiene (Sample E). The results provided in Table 7, demonstrate that the rubber sample containing the grafted material had worse wet braking results, and near equivalent rolling resistance.

TABLE 7

| Physical Property | Sample 10 | Sample E |
|---|---|---|
| Shore A | 68 | 67 |
| MH-ML | 16.2 | 18.4 |
| M100% | 2.7 | 2.2 |
| M300% | 8.5 | 5.6 |
| Elongation % | 415 | 603 |
| Tensile Strength | 12.8 | 14.3 |
| Rebound (23° C.) | 38 | 38 |
| Rebound (70° C.) | 52 | 52 |
| Tan δ (0° C.) | 0.21 | 0.19 |
| Tan δ (60° C.) | 0.12 | 0.11 |

### Example 7

The effect of the degree of functionalization was finally examined by preparing three samples according to the Compounding Procedure. Sample 11 contained a non-functionalized low molecular weight polybutadiene, Sample F contained a low molecular weight polybutadiene with one terminal silane, and Sample G contained a low molecular weight polybutadiene with two terminal silanes. The results in Table 8 demonstrate that the addition of a low molecular weight polybutadiene having one terminal silane resulted in a sample with greatly improved properties and the use of a low molecular weight polybutadiene having higher siloxane functionalization provides some benefit with respect to rolling resistance.

TABLE 8

| Physical Property | Sample 11 | Sample F | Sample G |
|---|---|---|---|
| Viscosity ML(1 + 4) | 93 | 63 | 66 |
| MH-ML | 20.3 | 12.5 | 17 |
| Shore A | 27 | 52 | 63 |
| M100% | 2 | 1.7 | 3.9 |
| M300% | 7.2 | 9.2 | 10.5 |
| Tensile Strength (Mpa) | 18.7 | 18 | 15 |
| Elongation (%) | 420 | 320 | 350 |
| Tan δ (0° C.) | 0.27 | 0.37 | 0.37 |
| Tan δ (60° C.) | 0.13 | 0.11 | 0.09 |

Comparing the results of Examples 1-7 demonstrates that silane functionalized low molecular weight elastomers are effective and provide improved silica dispersion and dynamic properties for the rubber compounds in which they are incorporated. The degree of filler dispersion and improvement to the dynamic properties is dependent on the molecular weight of the elastomer and the degree and location of functionalization. Suprisingly, it has been found that functionalized low-molecular weight oligomers are preferable to higher molecular weight oligomers, terminal functionalization is preferred over grafting, and difunctional termination is preferable over mono-functional termination.

Low molecular weight oligomers have higher mobility in a shear-mixed compound than high molecular weight polymers or elastomers. By including reactive functional groups to these low molecular weight oligomers, they become much more efficient at reacting with the filler surface or with the added silane coupling agents than high molecular weight analogs. The result is that less (by weight) functionalized oligomer needs to be incorporated to produce the same performance advantages.

While preferred embodiments of the invention have been shown and described herein, it will be understood that such embodiments are provided by way of example only. Numerous variations, changes, and substitutions will occur to those skilled in the art without departing from the spirit of the invention. Accordingly, it is intended that the appended claims cover all such variations as fall within the spirit and scope of the invention.

We claim:

1. A rubber composition comprising:
high molecular weight diene elastomer;
5 to 120 phr of silica;
0 to 100 phr of a carbon black; and
a silane modified oligomer comprising diene monomers in polymerized form,
wherein the silane modified oligomer has a molecular weight of 1000 to 5000 g/mol.

2. The rubber composition of claim 1, wherein the silane modified oligomer further comprises vinyl aromatic monomers in polymerized form.

3. The rubber composition of claim 1, wherein the silane modified oligomer has a molecular weight of 2000 to 4000 g/mol.

4. The rubber composition of claim 1, wherein the silane modified oligomer has a molecular weight of 2500 to 3500 g/mol.

5. The rubber composition of claim 1, wherein the silane modified oligomer is a silane modified polybutadiene.

6. The rubber composition of claim 1, wherein the silane modified oligomer is terminally functionalized.

7. The rubber composition of claim 6, wherein the silane modified oligomer is monofunctional.

8. The rubber composition of claim 6, wherein the silane modified oligomer is difunctional.

9. The rubber composition of claim 1, wherein the rubber composition is sulfur-vulcanizable.

10. The rubber composition of claim 1, wherein the high molecular weight diene elastomer is selected from the group consisting of polybutadiene, polyisoprene, copolymers of butadiene and vinyl aromatic monomers or isoprene and vinyl aromatic monomers, and mixtures of two or more thereof.

11. A tire manufactured from the rubber composition of claim 1.

12. A method of making a rubber composition comprising compound mixing in situ:
high molecular weight diene elastomer;
5 to 120 phr of silica;
0 to 100 phr of a carbon black; and
a silane modified oligomer comprising diene monomers in polymerized form,
wherein the silane modified oligomer has a molecular weight of 1000 to 5000 g/mol.

13. The method of claim 12, wherein the silane modified oligomer has a molecular weight of 2500 to 3500 g/mol.

14. The method of claim 12, wherein the silane modified oligomer is terminally functionalized.

15. The method of claim 14, wherein the silane modified oligomer is difunctional.

16. The method of claim 12, wherein the silane modified oligomer is terminally functionalized with tetraethoxysilane.

17. The method of claim 12, wherein the silane modified oligomer further comprises vinyl aromatic monomers in polymerized form.

18. The method of claim 12 further comprising adding a sulfur-based vulcanization agent.
